(19) United States
(12) Patent Application Publication
(10) Pub. No.: US 2009/0218946 A1
(43) Pub. Date: Sep. 3, 2009

(54) Lamp and method for manufacturing same

(75) Inventor: Ingo Dunish, Wiesbaden (DE)

Correspondence Address: PERMAN & GREEN, 425 POST ROAD, FAIRFIELD, CT, 06824, US

(73) Assignee: PerkinElmer Optoelectronics GmbH & Co. KG, Wiesbaden (DE)

(21) Appl. No.: 11/914,038

(22) PCT Filed: Apr. 24, 2006
(86) PCT No.: PCT/EP06/03758

§ 371 Date: Jul. 14, 2008

(30) Foreign Application Priority Data
May 13, 2005 (DE) 10 2005 022 376.1

(51) Int. Cl. H01J 17/18; H01J 5/50; H01J 9/26

(52) U.S. Cl. 313/625; 313/318.01; 313/318.02; 445/44

(57) ABSTRACT

A lamp (1) has a preferably tubular container (10) consisting of at least partly transparent material and having a first opening (13) which is sealed by a metallic first seal (11) which preferably contains aluminum, wherein the surface of the first seal (11) facing the interior (17) of the container includes a convexly shaped portion (19).

The first closure can be melted on the tube.

The invention relates to a lamp as well as a manufacturing method therefor. Particularly, it relates to flash lamps.

A flash lamp according to the preamble of the independent claims is known from DE 102 57 477.4. FIG. 11 shows the seal known from DE 102 57 477.4. Reference numeral 6 denotes a glass tube which is sealed at one end by a melted-on aluminum seal 7. Towards the inner side of the tube, the seal 7 has a concave surface 8, i.e., an outwardly arching surface.

Here, the opening of a glass tube is sealed by melted-on aluminum. This may be carried out on both sides in the same way. In order to obtain favorable ignition characteristics of the flashtube, specifically formed auxiliary bodies made of specific materials are melted inside the flash lamp into the sealing aluminum. The auxiliary bodies are made of, or provided with, materials which easily emit electrons so as to be able to readily provide the electrons necessary for sparking.

In order to obtain favorable ignition characteristics substantial attention was put on the material selection for the auxiliary bodies because this may improve the ignition quality of the above-described flash lamps. In fact, good ignition of the flash lamps can be achieved by means of this technology. The separate auxiliary body was provided because it was not possible to directly provide the aluminum melted on for sealing the tube opening at the inner surface thereof with the desired material properties. Accordingly, it was necessary to insert a correspondingly made auxiliary body into the tube interior and to melt it onto the sealing aluminum to also bring it into electrical contact.

The known structure has the drawback that its manufacture is cumbersome and therefore expensive. First, the auxiliary body has to be produced, next it has to be inserted into the tube interior and then brought into contact in a suitable manner. Moreover, as an auxiliary body is provided in addition to the seal, the dimensions of the flash lamp are comparatively long as the flash length (gap between the electrodes) in the axial direction is lengthened by the axial extension of the two seals and that of the auxiliary body.

Both drawbacks—laborious and thus expensive manufacturing method and comparatively large design—comply less and less with modern requirements. On the one hand, more and more disposable cameras (i.e., which serve for exposing a single film) are also equipped with flash lamps. These must be especially cheap. Moreover, an increasing number of mobile electronic devices, such as palms, mobile phones, PDAs, are equipped with cameras which themselves require a flashlight. In this case, in particular the dimension is a critical value.

It is the object of the invention to provide a flash lamp and a manufacturing method therefor which permit the assembly of a compact and easily ignitable lamp of long durability in a simple manufacturing process.

This object is achieved by means of the features of the independent claims. The dependent claims are directed to preferred embodiments of the invention.

A lamp comprises a preferably tubular container consisting of at least partly transparent material, such as glass, in particular quartz glass or hard glass, with at least a first opening sealed by a metallic, preferably aluminum-containing first seal. The surface of the first seal facing the interior of the container includes a convex portion, in particular a dome arching towards the interior of the container. The angle between the inner wall of the container and the surface of the seal may be acute, particularly <90°, preferably <45°.

The connection of the first seal to the container and the container wall, respectively, can be achieved by melting the first seal onto the container surface.

A lamp, particularly a flash lamp, may include a preferably tubular container consisting of an at least partly transparent material, preferably glass, quartz glass or hard glass, which has a first opening sealed with a first seal that may be metallic and preferably contains aluminum. Inside the container there may be a material which easily emits electrons. The material may include barium and/or caesium. It may be caesium iodide.

Cameras and in particular portable telecommunications devices equipped with cameras may include the above-described flash lamps.

According to the invention the metal sealing the container opening has an electrical function as a cathode and a mechanical function as a seal. It has surprisingly been found that the comparatively low-melting aluminum is yet suitable as an electrode material. Due to its low vapor pressure, its low tendency to sputter and its good thermal conductivity it does not lead to any blackening of the inner wall of the lamp when it is used as an electrode material.

In the following, separate embodiments are described with reference to the drawings, wherein:

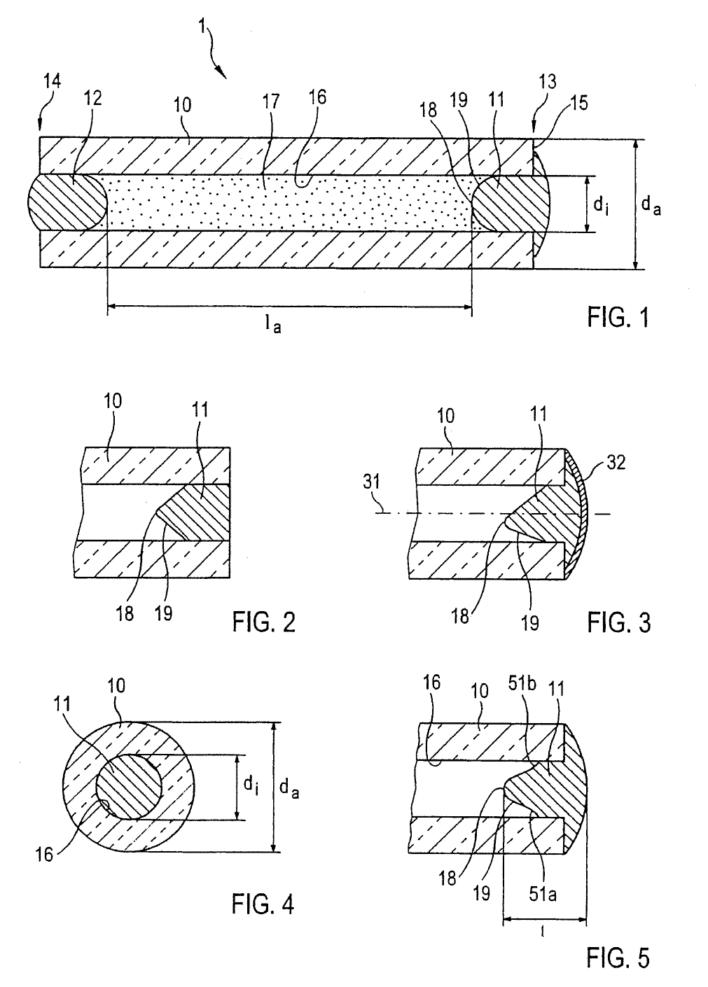

FIG. 1 shows the general view of a flash lamp,

FIG. 2 shows an embodiment of the first seal,

FIG. 3 shows another embodiment of the first seal,

FIG. 4 shows a cross-section through the lamp and the first seal,

FIG. 5 shows another embodiment of the first seal,

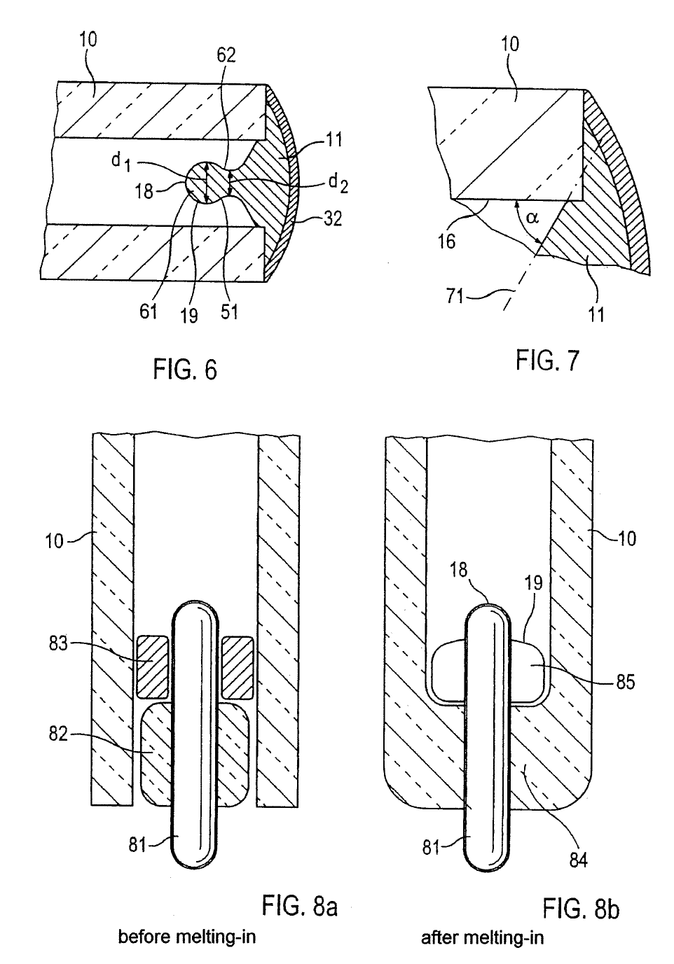

FIG. 6 shows another embodiment of the first seal,

FIG. 7 shows a detail to illustrate geometrical proportions,

FIGS. 8A and 8B show the view of a further embodiment,

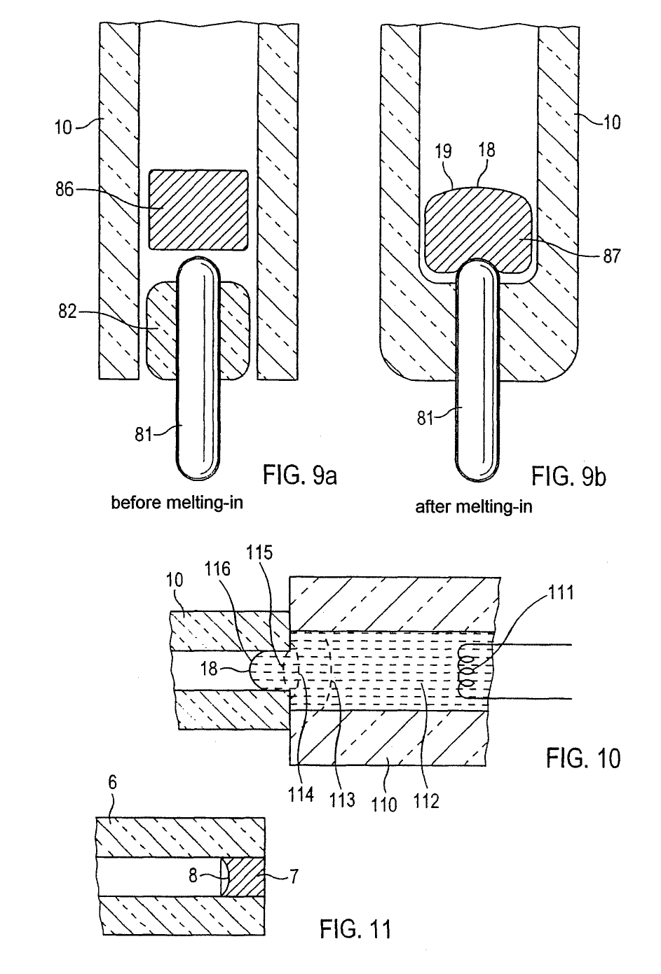

FIGS. 9A and 9B show the view of a further embodiment,

FIG. 10 schematically shows a process in an embodiment of a manufacturing method, and

FIG. 11 shows the illustration of a known seal.

FIG. 1 shows the general view of a lamp. It may be a flash lamp. Reference numeral 10 denotes a glass tube, 11 denotes the first seal, 12 stands for a second seal, 13 indicates a first end of the container, 14 signifies a second end of the container, 15 refers to a face surface of the container, 16 denotes the inner wall of the container. Reference numeral 17 stands for the interior of the container, 18 indicates the farthermost inner spot of the first seal, 19 refers to a convex portion, and 20 signifies a material in the interior of the container.

The lamp comprises an container which in the embodiment of FIG. 1 includes a glass tube 10 having a first end 13 and a second end 14, both of which are to be sealed. The glass tube 10 may completely or partly consist of quartz glass or hard glass. The first end 13 of the tube is sealed by the first seal 11. The second end 14 may be sealed by the second seal 12. Generally, a second seal 12, which is to be provided if needed, may be formed like the first seal 11 (as to shape and/or material). At least one of the seals and preferably both form the electric connections of the lamp. It is not necessary to differ between cathode and anode of the flash lamp in every case.

The first seal includes aluminum or an aluminum alloy. Due to their material characteristics with respect to durability, connectibility with the surrounding glass and electric values, aluminum and aluminum alloys are very suitable materials. The seal does not include auxiliary bodies, at least not of the kind which would have an electrical function as an interior anode or cathode. The surface of the first seal 11 facing the interior 17 of the container may directly be the material of which the first seal 11 is made. Its material composition may be comparatively homogeneous across the whole volume, which, however, does not exclude the provision of coating layers. It is preferred for the first seal not to include any auxiliary body. It will then have a comparatively homogeneous structure. However, a contact may for example be cast onto or into the outside.

When the first seal is produced (attachment to the tube), it is ensured that in the end the interior surface of the first seal 11 is not oxidized. This may comprise removing any previously generated oxide layers and/or subsequent working in an inert or evacuated environment.

The first seal 11 may be formed inside without an auxiliary body. The surface of the first seal 11 facing the interior 17 of the container is convex in at least some parts and may be dome-shaped, as shown in FIG. 1. Here, “convex” should be understood as parallel to the longitudinal direction of the lamp (transverse direction of FIG. 1) in a sectional plane.

The connection of the first seal 11 to the glass tube is vacuum-tight and gastight, respectively. Neither does ambient air from outside enter into inside the glass tube nor does the gas filling of the tube in turn pass from inside to the outside during the life-time of the flash lamp. The gastight connection between the first seal 11 and the glass tube 10 can be made at the inner wall 16 of the glass tube 10. However, the connection between the first seal 11 and the face 15 of the glass tube may also be gastight if and as far as this face 15 is covered by the first seal 11.

The outside surface of the first seal 11 may level with the face 15 of the tube 10. It may also arch convexly to the outside or concavely to the inside. The first seal 11 may completely or partly cover the face 15. On the left, FIG. 1 shows a seal 12 that does not cover the face of the tube 10 and the outside surface of which convexly arches to the outside. The first seal 11 on the right-hand side of FIG. 1 is also convex on the outside and partly covers the face 15.

Reference numeral 18 denotes the spot of the first seal 11 extending farthermost into the tube, i.e. which is closest to the other, opposite electrode. In any way, it is preferred that this portion 18 be convex. The first seal 11 is electrically conductive and forms a first electrode of the lamp. The second seal 12 may be conductive and form the second electrode of the lamp. The foremost portion 18 does not abut the inner wall 16 of the glass tube 10. Rather, it is spaced apart therefrom, preferably by at least 10% of the inner diameter dᵢ of the tube.

The invention as described by means of the embodiment of FIG. 1 is an obvious improvement of the known flash lamp. It has been shown that good ignition characteristics can already be achieved if the inner surface of the seal is convex. A specific electrode material which easily emits electrons is not necessary. Therefore, the auxiliary body and the production labor related thereto are no longer required. The dimension is reduced according to the omitted auxiliary body.

FIG. 2 shows another embodiment of the first seal. In the Figures, the same reference numerals generally refer to the same features. The first seal 11 has a convex portion 19 which is formed in a comparatively pointed shape. In an extreme case, it might be a conical construction of which the point, which also forms the farthermost inner portion 18, is hardly rounded or not rounded at all. The outside surface of the first seal 11 is level and located in the same plane as the face 15 of the tube 10.

FIG. 3 shows an asymmetrical embodiment. Reference numeral 31 shows a symmetry axis which in the case of a glass tube is its longitudinal axis in the center. The first seal 11 is asymmetrically shaped with respect to the symmetry axis 31. Though it includes a convex portion 19, the farthermost inner portion 18, however, is not positioned on the symmetry axis 31 but is offset against it to the side (vertical direction in the drawing plane). But it does not abut the inner wall 16 of the tube either. The offset against the symmetry axis 31 is preferably smaller than 30% of the inner diameter dᵢ, more preferably smaller than 15% or smaller than 5%.

The outside surface of the first seal 11 can be shaped in such a way that it is solderable. For example, the shaping may comprise a coating 32 which completely or partly covers the outside surface of the first seal 11. The coating consists of a different material or alloy than the material of the first seal 11.

FIG. 4 shows a section through the flash lamp perpendicular to its longitudinal axis near the face 15. The section runs through the material of the tube 10 as well as the material of the first seal 11. The interface between the two materials at the inner surface 16 of the tube 10 is the gastight connection sealing the outer space against the interior. The shape of the cross-section may be circular, but does not have to be. It may be oval. The shape of the cross-section may be constant or variable along the length of the lamp (transverse direction in FIG. 1). The dimensions, such as the inner diameter dᵢ or the outer diameter dₐ, may also be constant or variable along the length.

In the case of a constant circular cross-section, the outer diameter dₐ is preferably <20 mm, more preferably <10 mm, more preferably <5 mm and more preferably <3 mm. The inner diameter dᵢ is preferably <18 mm, preferably <8 mm, more preferably <3 mm, more preferably <2 mm. The flash length 1a (gap between the electrodes of the lamp, more concretely between the foremost portions 18 of the seals) is preferably <15 mm, more preferably <6 mm, more preferably <3 mm, more preferably <2 mm.

FIG. 5 shows an embodiment of the first seal 11 which also includes concave portions 51a, 51b in the section plane parallel to the longitudinal direction. It is not necessary that the complete inner surface of the first seal 11 be convex. Apart from the convex portion 19 a concave portion 51 may be provided as well. In the embodiment of FIG. 5, a concave portion 51, which in the present embodiment reaches up to the inner wall 16 of the glass tube 10, is concentrically located around the convex portion 19. The farthermost inner portion 18 of the first seal 11 is located in the convex portion 19.

FIG. 6 shows another embodiment of the first seal 11. The convex portion 19 is shaped like a head. A concave portion 51 forms a constriction 62 which forms the head 61 as a convex portion 19. The diameter d₁ of the head 61 is larger than the diameter d₂ of the constriction 62.

FIG. 7 shows a detail as to dimensioning instructions. The angle α between the inner wall 16 of the tube 10 and the surface of the first seal 11 is shown. It is taken to the surface of the first seal 11 between the inner wall 16 and the tangent. The angle α is preferably <90°, more preferably <60°, more preferably <30°. As far as the proportions are not constant, average values across the circumference will have to be applied. In this case it is not necessary to apply microscopic proportions but is possible to consider the geometry prevailing in a portion the size of which is 10% of the inner diameter dᵢ away from the inner wall 16 towards the center.

The material of the first seal contains aluminum. It may be a specific aluminum alloy. The aluminum or its alloy does not include elements which vaporize easily. Pure aluminum (weight proportion in particular >98%, preferably >99.9%) may also be used.

The interior 17 of the lamp contains an inert gas, preferably xenon, at a predetermined filling pressure. It is preferred for the interior 17 of the lamp to also contain a material which easily emits electrons. The material may include pure caesium and/or barium or compounds of these elements. It may include caesium iodide. At room temperature, the material is present as gas or vapor. Liquid droplets may also be present.

As far as it is stated that the first seal does not include an auxiliary body this may be understood implicitly or to the effect that it does not include an auxiliary body with an electrical function, in particular as an inside cathode and anode, respectively, of the flash lamp. However, auxiliary bodies with a different function, for example, for forming a volume at the seal, may be provided, such as a molded-in body consisting, for example, of glass, which seals at least a part of the volume of the opening and is at least partly surrounded by the aluminum-containing material.

Preferably at least 20%, more preferably at least 40%, of the surface of the first seal located inside the container are convexly shaped.

Starting from the face 15 of the tube, the depth of penetration t of the first seal 11 into the interior of the tube is preferably smaller than twice the inner diameter dᵢ of the tube.

The first seal can be melted on the container wall—as schematically shown in FIG. 10—as a method for manufacturing the seal and the lamp, respectively, in a way that the liquid or doughy material 112 of the seal is pressed against the capillary resistance and possibly against the material resistance from a supplied external device 110 into the opening of the container 10 to be sealed where it cools and solidifies. When it is pressed inside, the material at first only passes to the face of the tube 10 (dashed surface 114) while lying inside the device 110 (dashed surface 113), then begins to extend into the tube 10 (dashed surface 113) and finally assumes the ultimate position (surface 113) in which it solidifies. The symbol 111 denotes heating means. Controlled pressing means which effect that the material is pressed inside are not shown. An optical sensor may be provided for the control feedback.

Comparatively pure aluminum can be processed in a temperature range of above 660° C. and preferably below 700° C. It may also be processed in a temperature range below 660° C. and preferably above 640° C. When it is still in a warm state exchange processes (diffusion) after the pressing-in take place between the seal material and the material of the container wall which result in an intimate and durable vacuum-tight connection.

Depending on the temperature of the pressed-in material the process may include features of impact extrusion, i.e. wherein more or less doughy material is pressed into the opening with the required pressure.

As an alternative, the method may provide the formation of a preshaped solid formed body which is positioned in the opening to be sealed and, if needed, is subsequently heated together with the material of the container until is softens (doughiness) or melts to a degree that it melts onto the wall.

In all above-mentioned method options the container material may be preheated at least in the area of the opening to be sealed, particularly up to a temperature of over 100° C., preferably over 200° C. Method processes may take place in an inert atmosphere or in a vacuum. After the material has been melted on, it is possible to control the course of the cooling, for example via adjusting the ambient temperature, heat supply, cooling or the like. These parameters may also change with time.

In all previous embodiments, the metal seal assumed an electrical function (in particular contacting from the inside of the lamp to the outside of the lamp, formation of electrodes, arranging the ignition and burning characteristics) as well as a mechanical function (gastight, preferably vacuum-tight seal of an opening). In the embodiments described below with reference to FIGS. 8 and 9, however, a division of labor can be made such that the mechanical function (sealing) is effected by a glass/glass connection and a glass/metal connection, respectively, with the metal being a contact pin in the latter that penetrates the glass seal and preferably is comparatively refractory, for example includes molybdenum or tungsten or Kovar (Fe—Ni—Co alloy). It is not necessary to produce a gastight or vacuum-tight glass/aluminum connection such that insofar operations under protective gas or in an evacuated state may be avoided. The electrical function in the interior on the other hand is fulfilled by a body located inside and including or consisting of aluminum. This body may have shape features towards the interior, in particular a convex portion 19, as described in relation to the previous embodiments.

FIG. 8a shows the preparative step during the manufacture of the lamp and in particular the sealing of one end of the lamp. Reference numeral 81 denotes a metal pin which contributes to the electric contacting from the outside to the inside of the lamp. It is preferred that it includes a refractory material (melting point >1000° C.), such as molybdenum and/or tungsten and/or Kovar. This pin 81 is provided in advance with a collar 82 made of glass by melting it for example vacuum-tightly onto the pin 81, the outer diameter of which is slightly smaller than the inner diameter of the tube 10. Moreover, a body 83 consisting of a metal material, in particular including or consisting of aluminum, is loosely placed into the interior of the lamp. The body 83 may be an annular body which is pulled over the inner end of the pin 81. The outer dimensions of the body 83 are also smaller than the inner dimensions of the tube 10.

As shown in FIG. 8a, this structure is pushed inside the tube 10. This may be effected in an ambient atmosphere and at room temperature. Then the general structure is heated. This results in the glass collar 82 melting onto the inner wall of the tube 10, thus causing the sealing of the tube. The body 83 will also melt, attach to the inner wall of the tube and also melt onto the pin 81. The connection between the melted-on body 83 (see body 85 in FIG. 8b) and the inner wall of the tube 10 need not be gastight but may be a simple physical, electrically conductive adjacency.

FIG. 8b shows the final state: The body 85, the shape of which has been changed (due to melting and resolidification) adjoins the pin 81 on the one hand and the inner wall of the tube 10 on the other hand. The pin 81 penetrates the body 85 and its inner end forms the innermost portion 18. The symbol 84 denotes the material which corresponds to the preglassification 82 and is intimately amalgamated with the inner wall of the tube 10. The pin 81 has an end protruding outside which is used for the outer contacting of the lamp.

Thus, with its electric properties the inner aluminum body 85 may contribute to the improvement of the discharge characteristics and ignition characteristics of the tube. In particular, it has surprisingly been found that aluminum is generally well suited as an electrode material. It has a low tendency to sputter and a low vapor pressure and, contrary to the usual expectations, will thus not contribute to blackening the inner wall of the tube even after repeated discharges despite its comparatively low melting point. This especially applies if comparatively pure aluminum is used (also in the embodiments described before), that is, aluminum of a purity of >99 wt. %, preferably >99.9 wt. %, more preferably >99.97 wt. %.

FIGS. 9a and 9b qualitatively show the same Figures as FIGS. 8a and 8b such that in the following only the differences are described. In FIG. 9a, the preformed body 86 is no longer shaped as a cylinder in such a way that it could be pushed over a free end of the pin 81. It is rather a block that tends to be massive and simply lies on the free end of the pin 81 before it is melted on. The material of the block 86 may be aluminum or include aluminum and may particularly be of a purity as described above. The inner end of the pin 81 is comparatively short but it penetrates the preglassification 82 towards the inside such that the pin 81 may be metallic resulting from the metal of the body 86 and thus be electrically contacted therewith.

In the final state (FIG. 9b) the melted-on and resolidified body 87 covers the pin 81 completely such that the body 87 exclusively effects the electrical contacting towards the inside. The farthermost inner portion 18 then corresponds to those as shown in FIG. 1 to 7.

In the embodiment of FIGS. 9a and 9b an annular body 83 as shown in FIG. 8a may initially be used, as a massive body 86 as shown in FIG. 9a may in turn initially be used in the embodiment of FIGS. 8a and 8b.

The features of the various embodiments described in the specification may be combined as far as they are no technical alternatives which exclude each other.

1. A lamp (1) comprising a preferably tubular container (10) consisting of an at least partly transparent material and having a first opening (13) which is sealed by a metallic first seal (11) which preferably contains aluminum,
characterized in that
the surface of the first seal (11) facing the interior (17) of the container includes a convexly shaped portion (19).

2. The lamp according to claim 1, characterized in that the first seal (11) consists of aluminum or an aluminum alloy which is melted on the container wall (16), preferably an inner wall.

3. The lamp according to claim 1 or 2, characterized in that the first seal (11) does not include an auxiliary body with an electrical function.

4. The lamp according to one or more of the preceding claims, characterized in that the surface of the first seal (11) facing the interior (17) of the container includes a dome arching towards the interior of the container.

5. The lamp according to one or more of the preceding claims, characterized in that the first seal (11) is vacuum-tightly connected to the inner wall (16) of the container.

6. The lamp according to one or more of the preceding claims, characterized in that the first seal completely or partly covers the face (15) of the container (10).

7. The lamp according to one or more of the preceding claims, characterized in that the container (10) includes a second opening (14) which is sealed by a metallic second seal (12) preferably containing aluminum and extending into the interior of the container, with the surface of the second seal (12) that faces the interior of the container comprising a convexly shaped portion.

8. The lamp according to claim 7, characterized in that the second seal (12) has the same design as the first seal (11).

9. The lamp according to one or more of the preceding claims, characterized in that the surface of the first seal inside the tube comprises a concave portion (51, 62), particularly a circumferential constriction (62).

10. A lamp, particularly according to one or more of the preceding claims, comprising a preferably tubular container (10) consisting of an at least partly transparent material and having a first opening (13) which is sealed by a first seal (11) that preferably contains aluminum,
characterized in that
a material (20) which easily emits electrons is located in the interior (17) of the container.

11. The lamp according to claim 10, characterized in that the material includes caesium and/or barium.

12. The lamp according to claim 10 or 11, characterized in that the material is or includes caesium iodide.

13. The lamp according to one or more of claims 10 to 12, characterized in that at 20° C. the material is present as a gas or vapor.

14. The lamp according to one or more of the preceding claims, characterized in that the outside surface (32) of the first seal (11) is treated such that it is solderable.

15. The lamp according to one or more of the preceding claims, characterized in that it is a flash lamp.

16. The lamp according to one or more of the preceding claims, characterized in that an inert gas, particularly xenon, is present in the interior (17) of the container.

17. The lamp according to one or more of the preceding claims, characterized in that the container (10) is a tube having a cross-sectional shape remaining constant along its length.

18. The lamp according to one or more of the preceding claims, characterized in that the convex portion (19) is the farthermost inner portion (18) of the first seal.

19. The lamp according to one or more of the preceding claims, characterized in that the farthermost inner portion (18) of the first seal (11) is spaced apart from the central axis (31) of the lamp by no more than 25% of the inner diameter.

20. The lamp according to one or more of the preceding claims, characterized in that the cross-sectional shape of the outer diameter and/or the inner diameter is circular.

21. The lamp according to one or more of the preceding claims, characterized by one or more of the following features:
Flash length 1ₐ<5 mm, preferably <3 mm, more preferably <2 mm,
outer diameter dₐ<20 mm, preferably <10 mm, more preferably <5 mm, more preferably <3 mm,
inner diameter dᵢ<18 mm, preferably <8 mm, more preferably <3 mm, more preferably <1 mm.

22. The lamp according to one or more of the preceding claims, characterized by one or more of the following features:
The tube material is glass, preferably hard glass, more preferably quartz glass,
the first seal includes an aluminum alloy.

23. The lamp according to one or more of the preceding claims, characterized in that the first seal protrudes into the interior of the container.

24. The lamp according to one or more of the preceding claims, characterized in that at least 50% of the surface of the first seal exposed inside the container are convex.

25. The lamp according to one or more of the preceding claims, characterized in that the angle between the surface of the first seal inside the container and the inner wall of the container is smaller than 90°, preferably smaller than 60°.

26. The lamp according to one or more of the preceding claims, characterized by a wire pin.

27. A lamp, particularly according to one or more of the preceding claims, comprising a preferably tubular container (10) consisting of an at least partly transparent material and having a first opening (13) which is gastightly sealed by a glass seal penetrated by a contact pin,
characterized in that
in the interior (17) of the container on the inner side of the glass seal a body is provided which includes or consists of aluminum and touches the contact pin.

28. The lamp according to claim 27, characterized in that the glass seal is melted on the contact pin and the container wall.

29. The lamp according to claim 27 or 28, characterized in that the body is melted on the contact pin.

30. The lamp according to one or more of claims 27 to 29, characterized in that the contact pin protrudes into the interior of the container.

31. The lamp according to one or more of claims 27 to 29, characterized in that the contact pin is covered by the body.

32. The lamp according to one or more of claims 27 to 31, characterized in that the body adjoins the container wall.

33. A method for manufacturing a lamp which is preferably formed according to one or more of claims 1 to 26 in which at least one end of a transparent tube is sealed by a seal,
characterized in that
the material of the seal is heated at a distance from the lamp to be manufactured and pressed in a doughy or liquid state from outside into the opening to be sealed where it solidifies.

34. The method according to claim 33, characterized in that the tube is preheated.

35. The method according to claim 33 or 34, characterized in that the cooling down is controlled in particular by cooling, by heat supply or by adjusting the ambient temperature.

36. The method according to one or more of claims 33 to 35, characterized in that work is carried out at least in part under a protective gas or in a vacuum.

37. A method for manufacturing a lamp which is preferably formed according to one or more of claims 27 to 32 in which at least one end of a transparent tube is gastightly sealed by a glass seal penetrated by a contact pin,
characterized in that
the glass seal is melted on the container wall and the contact pin, and
in the interior a body containing or consisting of aluminum is melted on the contact pin.

38. The method according to claim 37, characterized in that the melting of the glass seal on the contact pin is effected in advance and that the melting of the glass seal on the container wall and the melting of the body on the contact pin are effected simultaneously.

39. The method according to one or more of claims 37 or 38, characterized in that a formed body consisting of aluminum and the contact pin preglassed with the glass seal are inserted into the tube and that this assembly is heated.

40. The method according to one or more of claims 37 to 39, characterized in that the melting is effected in an ambient environment.

41. A wireless telecommunications device for transmitting and/or receiving information, characterized by a lamp according to one or more of claims 1 to 32.

42. A camera, characterized by a lamp according to one or more of claims 1 to 32.
